(19) United States
(12) Patent Application Publication
(10) Pub. No.: US 2005/0035096 A1
(43) Pub. Date: Feb. 17, 2005

(54) Method and apparatus for cleaning generator, turbine and boiler components

(76) Inventor: Chris A. Kilburn, Buskirk, NY (US)

Correspondence Address: HOFFMAN WARNICK & D'ALESSANDRO, LLC, 3 E-COMM SQUARE, ALBANY, NY, 12207, US

(21) Appl. No.: 10/883,198

(22) Filed: Jul. 1, 2004

Related U.S. Application Data
(63) Continuation-in-part of application No. 10/273,043, filed on Oct. 17, 2002, now Pat. No. 6,759,627.

(51) Int. Cl. B23K 26/36; B23K 26/14

(52) U.S. Cl. 219/121.68; 219/121.69

(57) ABSTRACT

A laser-based cleaning system for cleaning generator, turbine, and boiler parts. In one aspect, the invention includes a laser-based cleaning system for cleaning a power generation component, comprising: a laser positioned remotely from the power generation component for generating a laser signal; a member having a flexible, manipulable shaft; a robotic workhead attached to the member and capable of directing a laser workhead at predetermined positions along the power generation component; a light guide that delivers a laser signal from the laser to the laser workhead, wherein the laser workhead can deliver a laser beam onto the power generation component surface to cause a cleaning; and a vacuum system for vacuuming debris created by the cleaning.

### CROSS REFERENCE TO RELATED APPLICATIONS

This is a continuation-in-part application of prior co-pending application Ser. No. 10/273,043 filed on Oct. 17, 2002.

### BACKGROUND OF THE INVENTION

1. Technical Field

The present invention relates to cleaning systems, and more particularly relates to a laser based ablation method for cleaning generator, turbine, and boiler components.

2. Related Art

Maintaining and cleaning large-scale turbine, generator, and boiler components (referred to collectively as “power generation components”) such as those found in power generation plants, represent a significant operational cost. The combination of intense stresses placed on the components and contaminants introduced into the components requires that such large-scale systems follow a strict maintenance and inspection schedule. Unfortunately, this results in these machines being taken “off-line” for a period of time for servicing. Every hour of downtime results in significant lost revenue, particularly in power generation plants and the like. Accordingly, the need for quick and efficient, waste reducing cleaning techniques for turbine and generator components remains an ongoing challenge.

Cleaning generator, turbine, or boiler components may for instance require a complete disassembly, e.g., removal of the turbine from its housing, removal of the rotating field from the stator core, etc. The process of completely disassembling such a machine is a complex and expensive process. In the past, effectively cleaning certain components without a complete disassembly was almost impossible given that a foreign material (e.g., blast media) would need to be introduced, therefore potentially contaminating other parts of the machine.

Exemplary components requiring cleaning include turbine blades, the generator stator core, rotating field coils, rotor forging, retaining rings, condenser tubes, boiler tubes, etc. Cleaning involves removing dust, oily deposits, combustion deposits and other surface contamination. For example, turbine parts, such as turbine blades may require the removal of built up debris that is reducing the overall efficiency of the machine, or impeding inspection. Past methods for cleaning such parts typically included a high-pressure application of aluminum oxide, glass bead, or CO₂.

Cleaning generator parts often involves removal of residual insulation and resins from the coil slots in the rotor forging and stator core when the windings are removed for a rewind. The current methods of cleaning such components are essentially manual, e.g., using scrapers made of TEXTOLITE™, wiping with rags soaked in approved cleaning solutions, and polishing with a clean dry rag. Likewise, if the rotor coils are to be reused, removal of insulation and resins from the coils is also required. Rotor forging and rotor coils to be reused are often cleaned by blasting with glass beads. Rotor coils wrapped with glass mica tape can also be cleaned by heating in an oven to burn off the tape and subsequently cleaned with approved solvents and rags.

The above-described methods are not only labor intensive, but also pose an environmental hazard. For example, the process of removing and disposing of the used glass beads and corncob, as well as processes related to collecting and disposing of the contaminated rags after cleaning create environmental waste. Workmen are exposed to hazardous chemical cleaners and are subjected to potential exposure to airborne contamination of the media used for blast cleaning. The blast cleaning media can escape from the enclosure and contaminate the surrounding area. Accordingly, there exists a need to overcome the problems faced by prior approaches.

### SUMMARY OF THE INVENTION

The present invention addresses the above-mentioned problems, as well as others, by providing a cleaning system and method that utilizes a portable workhead to direct a pulsed laser beam to a surface of a generator, turbine or boiler component. In a first aspect, the invention provides a laser-based cleaning system for cleaning blades of a turbine rotor assembly, comprising: a laser positioned remotely from the turbine rotor assembly for generating a laser signal; a laser workhead that receives the laser signal via a light guide, wherein the laser workhead is positionable proximate a blade in the turbine rotor assembly and can deliver a laser beam onto a surface of the blade to cause a cleaning of the blade; and a vacuum system for vacuuming debris created by the cleaning.

In a second aspect, the invention provides a method for laser-based cleaning of blades in a turbine rotor assembly, comprising: positioning a laser remotely from the turbine rotor assembly; mounting a robot proximate the turbine rotor assembly; providing within the robot a laser workhead that receives a laser signal from the laser via a light guide; positioning the workhead proximate a first turbine blade such that the workhead can deliver a laser beam onto the surface of the first blade; robotically moving the workhead along the first blade in a preprogrammed manner while the laser beam ablates the surface of first blade to effectuate a cleaning of the first blade; and vacuuming debris caused by the ablation.

In a third aspect, the invention provides a laser-based cleaning system for cleaning a rotor bore within a turbine shaft, comprising: a laser positioned remotely from the turbine shaft for generating a laser signal; a robot capable of traversing the rotor bore and directing a laser workhead at predetermined positions along the rotor bore surface; a light guide that delivers a laser signal from the laser to the laser workhead, wherein the laser workhead can deliver a laser beam onto rotor bore surface to cause a cleaning; and a vacuum system for vacuuming debris created by the cleaning.

In a fourth aspect, the invention provides a laser-based cleaning system for cleaning power generation components (turbine, generator, etc.), comprising: a laser workhead that receives the laser signal via a light guide, wherein the laser workhead is positionable proximate a component and can deliver a laser beam onto a surface the component to cause a cleaning; a laser positioned remotely from the laser workhead for generating a laser signal over the light guide; and a vacuum system for vacuuming debris created by the cleaning.

In a fifth aspect, the invention provides a laser-based cleaning system for cleaning a power generation component, comprising: a laser positioned remotely from the power generation component for generating a laser signal; a member having a flexible, manipulable shaft that can be remotely manipulated into an enclosure containing the power generation component; a laser workhead attached to the member that is capable of being positioned proximate the power generation component, wherein the laser workhead can deliver a laser beam onto the power generation component surface to cause a cleaning; and a light guide that delivers the laser signal from the laser to the laser workhead.

In a sixth aspect, the invention provides a method for laser-based cleaning of components in a turbine rotor assembly, comprising: positioning a laser remotely from the turbine rotor assembly; steering a flexible member through an opening leading to a component in a turbine housing; providing within the flexible member a laser workhead that receives a laser signal from the laser via a light guide; remotely positioning the workhead proximate the component such that the workhead can deliver a laser beam onto the surface of a component; remotely moving the workhead along the component while the laser beam ablates the surface of the component to effectuate a cleaning; and vacuuming debris caused by the ablation.

In a seventh aspect, the invention provides a laser-based cleaning system for cleaning a tubular opening, comprising: a laser positioned remotely from the turbine shaft for generating a laser signal; a flexible member capable of traversing the tubular opening and directing a laser workhead at predetermined positions along a surface of the tubular opening; a light guide that delivers a laser signal from the laser to the laser workhead, wherein the laser workhead can deliver a laser beam onto the surface to cause a cleaning; and a vacuum system for vacuuming debris created by the cleaning.

### DETAILED DESCRIPTION OF THE INVENTION

Overview

The present invention provides various laser-based systems for cleaning boiler, generator, and turbine parts (collectively “power generation components”). As noted above, cleaning such components is critical for maintaining performance, and is also a prerequisite for performing non-destructive evaluations (NDE's). It should be understood that the invention could be applied to any type of mechanical power system, e.g., boilers, gas turbines, steam turbines, jet engines, compressors, etc., that utilizes parts which require cleaning.

Turbine Blades

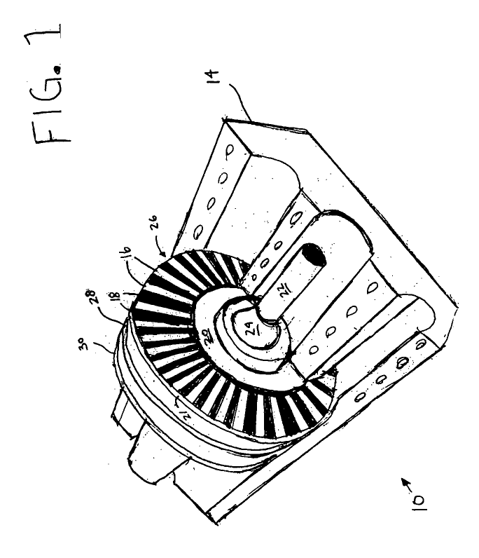

Referring now the drawings, FIG. 1 depicts an exemplary turbine system 10 seated in the bottom portion of a turbine housing 14. The turbine system 10 would typically sit on a turbine deck (not shown). The top portion of the housing (not shown) has been removed to expose the inner workings of the turbine system 10. The depicted turbine comprises a multistage turbine having three turbine units or turbine rotor assemblies 26, 28 and 30 mounted to a hub 24 on a shaft 22. Each assembly 26, 28, 30 comprises a plurality of radial extending blades 16 separated by a spacing 18. Depending on the particular specification, the configuration, spacing, pitch, etc., of the blades will vary. Each blade 16 is attached at a dovetail section 20 to the main shaft 22.

The ability to regularly clean the turbine blades 16 and dovetail section 20 has been shown to greatly improve performance of the turbine. Tests have shown that a 3-5 mil build-up of debris on the turbine blades will reduce the efficiency of the turbine 3-4%. Moreover, cleaning is also required before a non-destructive evaluation (NDE) can be performed (e.g., checking for failures, measuring tolerances, etc.). Prior to this invention, however, cleaning the turbine blades and dovetail section 20 required the entire turbine to be removed from its housing 14 to a clean-room environment, where the parts could be blasted with a foreign media. Such a disassembly resulted in extended downtime for the unit, which significantly drove up the costs of the cleaning process. Moreover, because prior cleaning techniques required the introduction of a blast media, it was not possible to clean the turbine in its housing.

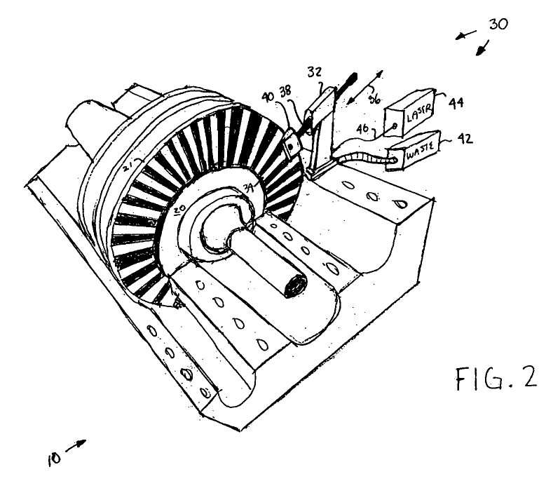

FIG. 2 depicts an embodiment of an exemplary cleaning system 30 for cleaning turbine parts, without the need of removing the turbine from lower housing 14. The cleaning system 30 includes a robot 32 for manipulating a laser workhead (not shown) capable of laser ablating debris from various turbine parts. In this exemplary embodiment, robot 32 comprises an arm 38 that moves a robotic work unit 40 along a turbine blade 34 in a generally radial motion 36. The robotic work unit 40 moves the laser workhead to various positions along the turbine blade using known robotic techniques. The laser workhead delivers a pulsed laser beam onto the surface of the blade using a pre-programmed pattern, ablating the surface and evenly removing built up debris. Any loose debris resulting from the ablation process is removed by a vacuum system, contained in the robotic workhead 40, to a remote waste container 42, thereby avoiding the possibility of contamination in the turbine system 10.

A remotely located laser 44 transmits a laser beam over a light guide 46 to the laser workhead thereby allowing a relatively small and versatile workhead to be used to remove debris from the turbine blades and related parts. As is described in more detail below, laser 44 may comprise any type of laser system (e.g., a YAG laser or a CO₂ laser) capable of delivering a relatively high power laser beam (e.g., 0.5-5 kilowatts) through a light guide. Suitable light guides include, for example, those available from OmniGuide Communications (<www.omni-guide.com>) and described by Dellemann et al. (“Perfect Mirrors Extend Hollow-Core Fiber Applications,” available at <www.omni-guide.com/Pages/TechPapers/OmniFeature.pdf>). Traditional fiber optic devices known in the art are likewise suitable for use in the claimed invention.

In addition, robotic workhead 40 may also include a non-destructive evaluation (NDE) system for examining the turbine component for cracks or other failures after it is cleaned. Known NDE techniques are presently utilized for the inspection of steam and gas turbine blades with an emphasis on detecting minute defects in the blades. High inspection sensitivity is obtained, for instance, by using video cameras along with specialized magnetic particle and eddy current inspection methods. Accordingly, the laser workhead of the present invention could be retrofitted to an existing NDE system, or vice versa. An exemplary NDE system is described in U.S. Pat. No. 5,189,915, SINGLE MODE ULTRASONIC INSPECTION METHOD AND APPARATUS, assigned to Reinhart & Associates, Inc., in Austin Tex., which is hereby incorporated by reference. Other exemplary systems are provided by the assignee and are described at their website at <reinhartassoc.com>.

In the exemplary embodiment shown, cleaning system 30 is mounted to a side portion of lower housing 14. However, it should be recognized that cleaning system 14 could be mounted anywhere relative to turbine system 10, (e.g., on the shaft, on the turbine rotor assembly itself, on the turbine deck, on a separate standalone device, etc.). Furthermore, the blades could be cleaned with a portable handheld unit, as opposed to robotics. After a set of blades is cleaned, the turbine rotor assembly can be rotated into position for a next set of blades, and so on, until all of the blades have been cleaned. The robotics necessary to carry out the cleaning operation could be implemented in any manner, and any such variations are believed to fall within the scope of the present invention. For example, the cleaning system 30 could be adapted to clean multiple blades and/or clean both sides of the blade during one pass. Furthermore, the cleaning system 30 could be adapted to clean the dovetail section 20, as well the outer ring 21.

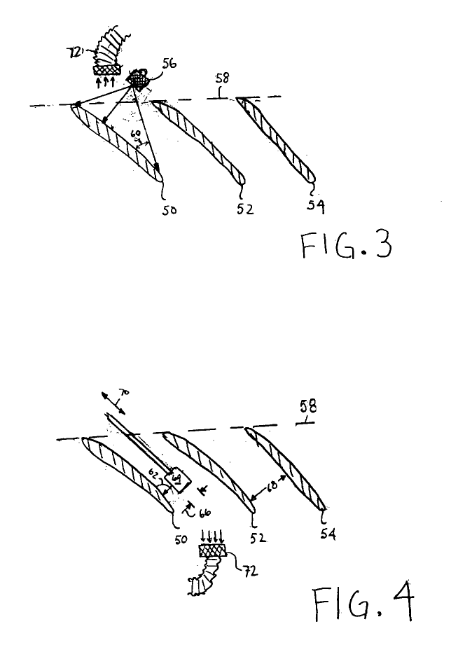

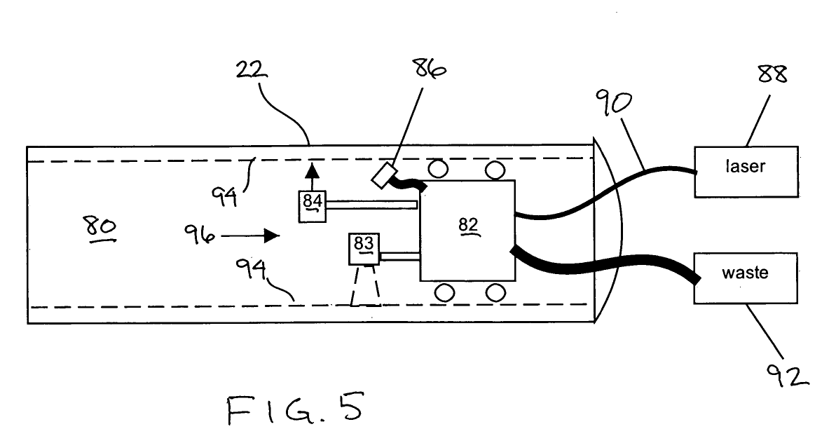

Referring now to FIGS. 3 and 4, a cutaway view looking down into a set of turbine blades 50, 52, 54 is shown. As can be seen, the blades are pitched such that they will be driven in a leftward or rightward direction when a fluid flow is passed therethough. The blade pitch may create an overlap among the blades, which adds complexity to the laser ablation operation. In the embodiment of FIG. 3, a laser workhead 56 is shown that operates externally (shown by dashed line 58) to the turbine rotor assembly. This embodiment assumes a “line of sight” application in which the entire surface can be cleaned from an externally positioned laser source. This embodiment may also be useful when the spacing between blades makes it impractical to insert a workhead between the blades. Located proximate laser workhead 56 is a vacuum system 72 for removing loose debris. In this embodiment, the laser workhead 56 does not need to enter into the spacing between the blades. Instead, the laser workhead can be angled so that the laser beam can reach the entire blade 50.

However, as the attack angle 60 becomes smaller, the efficacy of the laser ablation decreases. To compensate, the present invention will cause the laser system to either increase power or increase the ablation time in an amount proportional to attack angle 60. For instance, in a relatively straight ablation (i.e., attack angle 52 is 90 degrees +/−some predetermined variance), the present invention proposes a strip rate of a square foot per minute per kilowatt for a 1-2 mil ablation. As the attack angle 60 decreases, the strip rate would decrease proportionally to ensure adequate stripping.

FIG. 4 depicts a second embodiment for cleaning overlapping blades 50, 52, 54. In this case, laser workhead 64 is manipulated along arrow 70 into the spacing within the blades. To achieve this, the laser workhead 64 is designed to have a depth dimension 66 that is less than a minimal blade opening 68. Thus, a relatively perpendicular attack angle 62 can be maintained during the cleaning process. Also shown in FIG. 4 is an alternative vacuum system 72 location. Namely, in this embodiment, the vacuum system 72 is located on the opposite side of the turbine rotor assembly.

Rotor Bore

The interior of the shaft 22, referred to as the rotor bore 80 represents another important area of the turbine that requires regular cleaning, as the rotor bore is subject to regular non-destructive examinations. FIG. 5 depicts a cross-sectional view of the rotor bore 80 that includes a circular inner wall 94, which is cleaned with laser ablation by cleaning device 96. Cleaning device 96 comprises a robot 82 that traverses the inside of shaft 22 and transports a laser workhead 84 and vacuum system 86. Robot 86 comprises the necessary functionality to position laser workhead 84 throughout the bore 80, thereby allowing a continuous and uniform cleaning operation.

A laser 88 is positioned outside of the shaft 22, and communicates a laser signal through fiber optics 90. A waste collection system 92 is also positioned outside of the shaft 22 for the collection of debris captured by vacuum system 86. Any type of robot system capable of traversing a bore could be utilized. In addition, the cleaning device 96 may comprise an NDE system 83 that examines the surface after it is cleaned.

In addition to cleaning rotor bores, this configuration can be applied to clean any type of tubular opening, e.g., pipes, condenser cores, boiler tubes, etc.

Generator Parts

In addition to the turbine parts described above, the concepts of the present invention could be applied to other components, including generator parts. For instance, the copper bars that make up the generator windings also require regular cleaning. A robotic device containing a portable laser workhead could be utilized in a similar fashion to laser ablate debris therefrom. Similarly, the stator core could be cleaned using the present system. An NDE system could also be incorporated to inspect the parts after they are cleaned.

Laser System

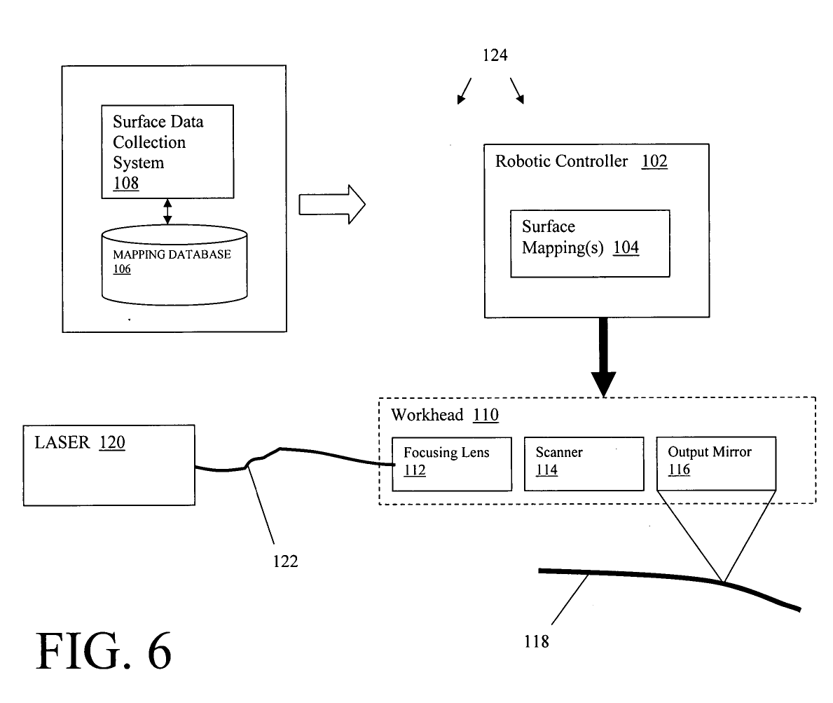

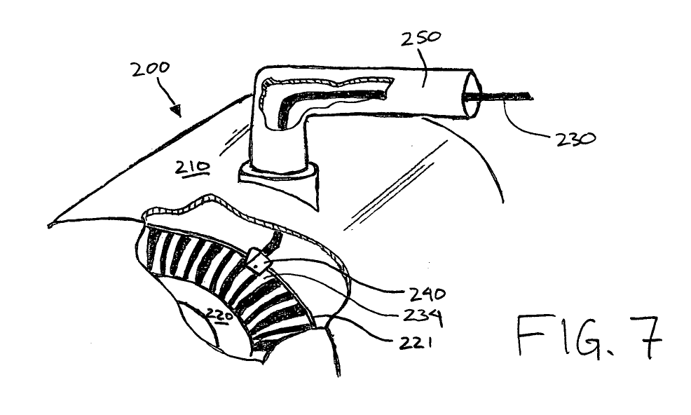

Referring now to FIG. 6, a laser system is shown, which generally comprises a laser 120 remotely connected to a laser workhead 110 via light guide 122. Workhead 110 is designed to laser ablate a predefined surface area on a work piece 118, e.g., a section comprising a one inch diameter circle. After a section is ablated, the process can be repeated on another section either by moving work piece 118 and/or workhead 110 until the entire work piece 118 has been cleaned.

Workhead 110 receives the laser signal from laser 120 and first passes the workhead through a focusing lens 112. Scanner 114 moves the beam to a new position for each pulse until a section is ablated. A typical system will generate pulses at a rate of 10-15 kHz. The beam may be moved in any pattern to ablate a section, e.g., a spiral, back and forth, etc. Output mirror 116 generates the focused beam onto the surface or work piece 118. A typical focused beam will be on the order 0.5 millimeters in diameter for a YAG laser, and as much as 0.5 inches for a CO₂ laser. As noted, after a section has been ablated, the workhead can be repositioned to a new section.

In order to achieve efficient ablation, the present invention proposes a power output of 1-2 kilowatts for laser 120. If necessary, several smaller lasers (e.g., two 600 watt lasers) could be utilized. Laser 120 is preferably an industrial laser capable of pulsed operation, e.g., a CO₂ laser, a Q switched Nd:YAG (“YAG”) or other YAG laser. U.S. Pat. No. 6,288,362 B1 issued to Thomas et al. on Sep. 11, 2001, entitled METHOD AND APPARATUS FOR TREATING SURFACES AND ABLATING SURFACE MATERIAL, describes such as system, and is hereby incorporated by reference. As noted above, a proposed strip rate for a 1-2 mil thickness ablation is approximately one square foot per minute per kilowatt.

As shown in FIG. 6, workhead 110 may be positioned from section to section by a robotic controller 102. Robotic controller 102, for example, moves workhead 110 along a turbine blade to achieve an automated and uniform ablation. Robotic controller may include a surface mapping 104 of the turbine part being cleaned. Surface mapping 104 defines the position and contours of the work piece being cleaned. Surface mapping 104 may be obtained by a surface data collection system 108, and be stored in mapping database 106. For example, because there exists numerous turbine systems, many different blade configurations and styles exist. Accordingly, a mapping for each different model could be stored in mapping database 106, and then uploaded to robotic controller 102 as needed.

As an alternative, a portable handheld device comprising workhead 110 could be used to clean turbine parts.

Methods Utilizing a Flexible Member

In some situations, it may be impractical to disassemble the turbine, generator, boiler, or other power generator, in order to clean and inspect its components. To address this, the present invention provides a laser workhead attached to a steerable, flexible member for remotely cleaning parts, e.g., contained in a housing. The flexible member can be remotely steered into locations within the power generator not otherwise accessible without disassembly. The laser workhead connected to a laser via a flexible light guide and optionally may include an NDE system and/or a vacuum system. The flexible member may be embodied in a boroscope or endoscope type device (or similar device having a flexible, manipulable shaft) such as those described by Szewczyk et al. in “An Active Tubular Polyarticulated Micro-System for Flexible Endoscope.” Such a device includes a steering mechanism that can manipulate the flexible member into an interior cavity, canal, tube, vessel, etc., and may include any number of systems to facilitate the process, e.g., light guides, tools, optics, electronics, image transmission systems, etc.

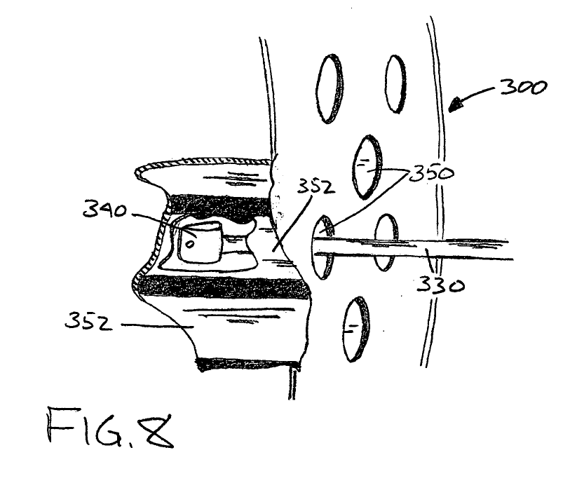

Referring now to FIG. 7, a partial cutaway view of turbine 200 and steam supply line 250 is shown. Using a flexible member 230, the laser system of the claimed invention can be employed to clean turbine blades 234 of a turbine rotary assembly without the need to disassemble turbine housing 210. Workhead 240 is passed through steam supply line 250 by means of flexible member 230 and positioned proximal to turbine blade 234. Workhead 240 could similarly be passed through inspection hand holes (not shown) or similar access points in turbine housing 210, rather than through steam supply line 250. Turbine blade 234 is then cleaned and inspected as described above. Workhead 240 may also be positioned to clean and inspect outer ring 221 and dovetail section 220. Similarly, workhead 240 could be used to clean any tubular power generation component, such as a rotor bore 80 as shown in FIG. 5, or other tubular opening. Such a tubular opening can be of any size or cross-sectional shape through which robotic workhead 240 can be manipulated.

Referring now to FIG. 8, a partial cutaway view of a condenser array 300 and condenser tube 352 is shown. Using a flexible member 330, the laser system of the claimed invention can be employed to clean condenser tubes 352. Robotic workhead 340 is inserted into condenser tube opening 350 and steered along the interior of condenser tube 352 by means of flexible member 330. The interior surface of condenser tube 352 is then cleaned and inspected as described above. The laser system of the claimed invention could similarly be used to clean and/or inspect the interior and exterior surfaces of a boiler tube (not shown) or similar power generation component.

As noted above, the invention may be implemented using a light guide comprising a low-loss waveguide that utilizes omnidirectional mirrors. This technology utilizes a 1-D photonic bandgap fiber to create a perfect mirror in which the fiber guides the light almost exclusively in its hollow core.

The foregoing description of the preferred embodiments of the invention has been presented for purposes of illustration and description. They are not intended to be exhaustive or to limit the invention to the precise form disclosed, and obviously many modifications and variations are possible in light of the above teachings. Such modifications and variations that are apparent to a person skilled in the art are intended to be included within the scope of this invention as defined by the accompanying claims.

1. A laser-based cleaning system for cleaning a power generation component, comprising:
a laser positioned remotely from the power generation component for generating a laser signal;
a member having a flexible, manipulable shaft that can be remotely steered into an enclosure containing the power generation component;
a laser workhead attached to the member that is capable of being positioned proximate the power generation component, wherein the laser workhead can deliver a laser beam onto the power generation component surface to cause a cleaning;
a light guide that delivers the laser signal from the laser to the laser workhead.

2. The laser-based cleaning system of claim 1, wherein the light guide comprises a 1-D photonic band gap fiber.

3. The laser-based cleaning system of claim 1, further comprising a vacuum.

4. The laser-based cleaning system of claim 1, wherein the workhead includes a non-destructive evaluation system for examining the power generation component during a cleaning operation.

5. The laser-based cleaning system of claim 1, wherein the member comprises at least one of a boroscope and an endoscope.

6. A method for laser-based cleaning of components in a turbine rotor assembly, comprising:
positioning a laser remotely from the turbine rotor assembly;
steering a flexible member through an opening leading to a component in a turbine housing;
providing within the flexible member a laser workhead that receives a laser signal from the laser via a light guide;
remotely positioning the workhead proximate a component such that the workhead can deliver a laser beam onto the surface of the component;
remotely moving the workhead along the component while the laser beam ablates the surface of the component to effectuate a cleaning; and
vacuuming debris caused by the ablation.

7. The method of claim 6, wherein the opening leading to the turbine housing comprises an inspection hand hole.

8. The method of claim 6, wherein the opening leading to the turbine housing comprises a steam supply line.

9. The method of claim 6, comprising the further steps of:
rotating the turbine rotor assembly after a first set of turbine blades is cleaned;
positioning the workhead proximate a second set of turbine blades; and
effectuating a cleaning of the second set of turbine blades in the same manner as the first set of turbine blades.

10. The method of claim 6, wherein the laser beam is generated with a power of approximately 0.5-5 kilowatts.

11. The method of claim 6, wherein each blade is cleaned according to a strip rate in which each 1-2 mil thickness of debris is ablated at a rate of one square foot per minute per kilowatt.

12. The method of claim 6, wherein the light guide comprises a 1-D photonic bandgap fiber.

13. The method of claim 6, comprising the further step of using the using the flexible member to perform a non-destructive evaluation of a turbine part.

14. The method of claim 6, wherein the flexible member includes at least one of a boroscope and an endoscope.

15. The method of claim 6, wherein the step of remotely moving the workhead along the blade is performed in a preprogrammed manner.

16. A laser-based cleaning system for cleaning a tubular opening, comprising:
a laser positioned remotely from the turbine shaft for generating a laser signal;
a flexible member capable of traversing the tubular opening and directing a laser workhead at predetermined positions along a surface of the tubular opening;
a light guide that delivers a laser signal from the laser to the laser workhead, wherein the laser workhead can deliver a laser beam onto the surface to cause a cleaning; and
a vacuum system for vacuuming debris created by the cleaning.

17. The system of claim 16, wherein the tubular opening comprises an opening selected from the group consisting of a condenser tube and a boiler tube.

18. The system of claim 16, wherein the tubular opening is cleaned according to a strip rate in which each 1-2 mil thickness of debris is ablated at a rate of one square foot per minute per kilowatt.

19. The system of claim 16, further comprising a system for performing a non-destructive evaluation of the opening.

20. The system of claim 16, wherein the flexible member is selected from the group consisting of a boroscope and an endoscope.
